(19) United States
(12) Patent Application Publication
(10) Pub. No.: US 2013/0177287 A1
(43) Pub. Date: Jul. 11, 2013

(54) REPRODUCTION APPARATUS, IMAGE CAPTURING APPARATUS, AND PROGRAM

(71) Applicant: Panasonic Corporation, Osaka (JP)

(72) Inventor: Toshiyuki NAKASHIMA, Hyogo (JP)

(73) Assignee: PANASONIC CORPORATION, Osaka (JP)

(21) Appl. No.: 13/738,145

(22) Filed: Jan. 10, 2013

(30) Foreign Application Priority Data
Jan. 11, 2012 (JP) 2012-002737

(51) Int. Cl. H04N 9/87; H04N 5/77

(52) U.S. Cl. CPC H04N 9/87; H04N 5/77
USPC 386/224; 386/239

(57) ABSTRACT

A reproduction apparatus which reproduces more appropriate frames when reproducing a moving picture with interpolation frame images inserted therein. A reproduction apparatus disclosed in this application is a reproduction apparatus for reproducing moving picture data including images of original frames and images of interpolation frames generated from the images of the original frame, the reproduction apparatus including a reproduction section for receiving the moving picture data and outputting the moving picture data to a display section, wherein the reproduction section selectively outputs image data of an original frame from the moving picture data to the display section based on an instruction from a user.

### BACKGROUND

1. Technical Field

The present application relates to a reproduction apparatus for reproducing image data including interpolation frames therein.

2. Description of the Related Art

Japanese Laid-Open Patent Publication No. 2010-177739 discloses an image processing apparatus. The image processing apparatus generates interpolation frame images to be inserted between frame images. The image processing apparatus of Patent Document No. 1 calculates the search area for a motion vector of an interpolation pixel included in an interpolation frame image based on a change in the pixel value within each frame of a plurality of frame images, and generates an interpolation frame image based on a motion vector estimated in the calculated search area.

### SUMMARY

With conventional techniques, reproduction of a movie file including generated interpolation frame images therein is not controlled as to reproduce more appropriate frames.

One non-limiting, and exemplary embodiment of the present disclosure provides a reproduction apparatus capable of reproducing more appropriate frames when reproducing a moving picture including interpolation frame images inserted therein.

In one general aspect, a reproduction apparatus disclosed herein reproduces moving picture data including images of original frames and images of interpolation frames generated from the images of the original frame. The reproduction apparatus includes a reproduction section configured to receive the moving picture data and output the moving picture data to a display section, wherein the reproduction section selectively outputs image data of an original frame from the moving picture data to the display section based on an instruction from a user.

According to the above aspect, it is possible to reproduce of a series of moving picture frame images, with interpolation frame images inserted between frame images, can be controlled so that more appropriate frames are reproduced.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF DRAWINGS

FIG. 1 is a block diagram showing a configuration of a digital video camera according to the present embodiment.

FIG. 2 is a block diagram showing a configuration of a recording section of an image processing section of the digital video camera according to the present embodiment.

FIG. 3 is a diagram illustrating the arrangement of frames with respect to the vertical sync signal for the digital video camera according to the present embodiment.

FIG. 4 is a block diagram showing a configuration of a reproduction section of the image processing section of the digital video camera according to the present embodiment.

FIG. 5 is a flow chart showing a reproduction operation performed by the digital video camera according to the present embodiment.

FIG. 6 is a block diagram showing another configuration of the reproduction section of the digital video camera according to the present embodiment.

### DETAILED DESCRIPTION

An embodiment will now be described in detail, referring to the drawings. Note however that unnecessarily detailed descriptions may be omitted. For example, detailed descriptions on what are well known in the art or redundant descriptions on substantially the same configurations may be omitted. This is to prevent the following description from becoming unnecessarily redundant, to make it easier for a person of ordinary skill in the art to understand. Note that the present inventors provide the accompanying drawings and the following description in order for a person of ordinary skill in the art to sufficiently understand the present disclosure, and they are not intended to limit the subject matter set forth in the claims.

### 1. Embodiment

First, an embodiment, in which the reproduction apparatus of the present disclosure is applied to a digital video camera, will now be described. In the following description, data representing each of the individual still images of a moving picture will be referred to a “frame image” or simply a “frame”. A frame to be inserted between two contiguous frames will be referred to as an “interpolation frame image” or simply an “interpolation frame”.

### 1-1. Outline

A digital video camera (hereinafter also referred to simply as a “camera”) of the present embodiment is an image capturing apparatus capable of capturing a moving picture. The digital video camera of the present embodiment is capable of converting a frame rate on-the-fly during the operation of capturing a moving picture, or after the operation, in response to a user instruction, etc. The digital video camera of the present embodiment changes the frame rate by inserting an interpolation frame image between original frame images obtained through an image capturing operation, the interpolation frame image being generated from the original frame images. For example, when performing movie capturing operation at 60 frames per second, the operation can be switched to a movie capturing operation at 120 frame per second by inserting interpolation frame images between frames. The time when the digital video camera switches frame rates from one to another may be when a user gives an instruction to change the frame rate, when information (e.g., brightness information) obtained from an image captured through an image capturing operation (hereinafter also referred to as a “captured image”.) is changed, or when a predetermined mode (e.g., a low-speed image capturing mode) is selected.

The digital video camera of the present embodiment selectively displays an original frame image of moving picture data that includes interpolation frames inserted therein when reproducing the moving picture data at a lower reproduction speed than normal, e.g., slow reproduction, or when pausing the reproduction.

### 1-2. Configuration of Digital Video Camera

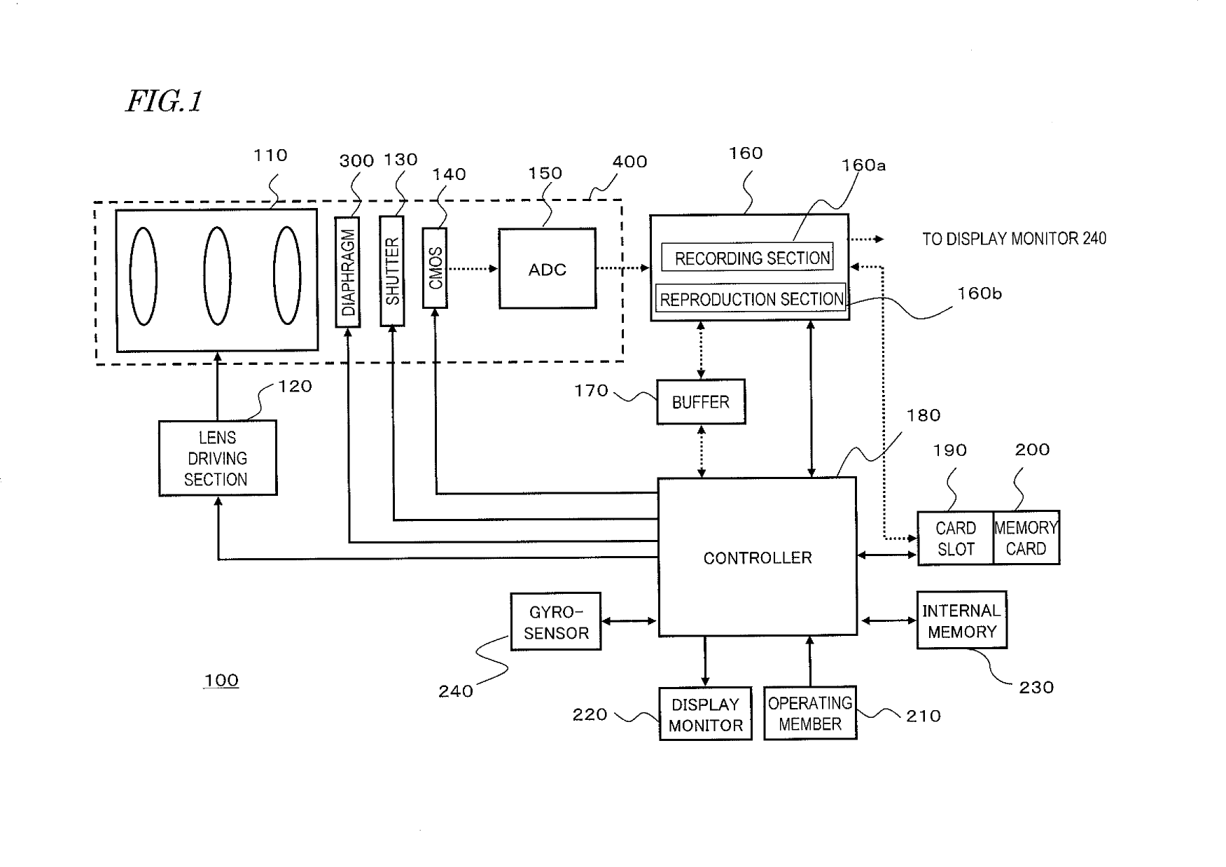

Now, a configuration of a digital video camera 100 according to the present embodiment will be described with reference to FIG. 1. FIG. 1 is a block diagram showing a configuration of the digital video camera 100. In this and other figures, a solid-line arrow in the block diagram mainly represents the flow of a control signal, and a broken-line arrow the flow of image data. The digital video camera 100 uses a CMOS image sensor 140 to capture an object image formed by an optical system 110 including one or more lenses. The image data generated by a CMOS image sensor 140 is subjected to various processes by an image processing section 160, and stored in a memory card 200. The optical system 110 has as a group of lenses, including a zoom lens and a focus lens. By moving the zoom lens along the optical axis, it is possible to enlarge or shrink the object image. By moving the focus lens along the optical axis, it is possible to adjust the focus of the object image. While three lenses are shown in FIG. 1 as an example, the number of lenses of the optical system 110 is appropriately determined in accordance with the required functionality.

A lens driving section 120 drives various lenses included in the optical system 110. The lens driving section 120 includes, for example, a zoom motor for driving the zoom lens and a focus motor for driving the focus lens.

A diaphragm 300 adjusts the size of the opening, thereby adjusting the amount of light to pass therethrough, in accordance with the user settings or automatically.

A shutter 130 blocks light from entering the CMOS image sensor 140.

The CMOS image sensor 140 is an image capturing device for generating image data through photoelectric conversion of an object image formed by the optical system 110. The CMOS image sensor 140 performs various operations, such as exposure, transfer, electronic shutter, etc. The CMOS image sensor 140 generates new image data at intervals of a certain amount of time. While the CMOS image sensor 140 is used as an image capturing device in the present embodiment, image capturing apparatuses of other types may also be used, such as a CCD image sensor or an NMOS image sensor.

An A/D converter (ADC) 150 is a circuit, electrically connected to the CMOS image sensor 140, for converting analog image data generated by the CMOS image sensor 140 to digital image data.

In the present embodiment, a plurality of elements including the optical system 110, the diaphragm. 300, the shutter 130, the CMOS sensor 140 and the ADC 150 together form an image capturing section 400. The image capturing section 400 generates and outputs digital moving picture data including a plurality of contiguous frames.

The image processing section 160 can be implemented by a digital signal processor (DSP), a microcomputer, or the like, for example. The image processing section 160 includes a recording section 160a for performing a process for recording image data generated through an image capturing operation, and a reproduction section 160b for performing a process for reproduction. Thus, the image processing section 160 functions as a recording apparatus and as a reproduction apparatus.

The recording section 160a of the image processing section 160 is electrically connected to the ADC 150, and performs various processes on the image data generated by the CMOS image sensor 140, to generate image data to be displayed on a display monitor 220, and image data to be stored in the memory card 200. The recording section 160a performs various processes, such as gamma correction, white balance correction, scar correction, etc., for example, on the image data generated by the CMOS image sensor 140. The recording section 160a compresses image data generated by the CMOS image sensor 140 in accordance with a compression scheme, etc., in conformity with the H.264 standard, the MPEG2 standard, or the like.

The recording section 160a can further calculate the motion vector based on the image data (frame image) generated by the CMOS image sensor 140. Then, the recording section 160a can generate an interpolation frame image by motion compensation based on the calculated motion vector and the frame image associated with the motion vector. Alternatively, the recording section 160a can generate an interpolation frame through averaging by adding together a plurality of correlated frame images at a predetermined ratio without using motion compensation. The details of the process of generating these interpolation frames will be described later.

A controller 180 is a control means for controlling the entire digital video camera. The controller 180 can be implemented by a semiconductor device, or the like. The controller 180 may be implemented only by hardware, or may be implemented by a combination of hardware and software. The controller 180 can be implemented by, for example, a microcomputer, or the like. Alternatively, it may be implemented by a single semiconductor chip, together with the image processing section 160, etc. As shown in FIG. 1, the controller 180 is electrically connected to the image processing section 160 and various other sections, and sends control signals thereto.

The controller 180 also generates the vertical sync signal. The operation of the digital video camera 100 is performed in accordance with the timing represented by the vertical sync signal generated by the controller 180.

A buffer 170 is electrically connected the image processing section 160 and the controller 180, and serves as a work memory thereof. The buffer 170 can be implemented by, for example, a DRAM, a ferroelectric memory, or the like.

A card slot 190 is capable of receiving the memory card 200, and can be mechanically and electrically connected to the memory card 200. The memory card 200 includes therein a flash memory, a ferroelectric memory, or the like, and can store data such as an image file generated by the image processing section 160.

The image data recorded on the memory card 200 is read out to the reproduction section 160b of the image processing section 160 and output to the display monitor 220, thereby displaying the video of the image data on the display monitor 220.

An internal memory 230 is implemented by a flash memory, a ferroelectric memory, or the like. The internal memory 230 stores a control program, etc., for controlling the entire digital video camera 100. The control program is executed by the controller 180.

An operating member 210 generally refers to a user interface via which user operations are accepted. The operating member 210 includes, for example, a cross-shaped key, an OK button, and the like, via which user operations are accepted.

The display monitor 220 is capable of displaying an image (through image) represented by image data generated by the CMOS image sensor 140, and an image represented by image data read out from the memory card 200. The display monitor 220 can also display various menu screens, etc., used for changing various settings of the digital video camera 100.

A gyrosensor 240 is a motion detector for detecting a shake in the yawing direction and a movement in the pitching direction based on the angular change over unit time, i.e., the angular velocity, of the digital video camera 100. The gyrosensor 240 outputs a gyro signal, representing the detected amount of movement, to the controller 180. Note that a motion detector of a different type, such as an acceleration sensor, may be provided instead of, or in addition to, the gyrosensor 240. There is no limitation on the configuration of the motion detector as long as it is a sensor capable of detecting the motion of the subject apparatus during an image capturing operation.

Note that the configuration described above is merely an example, and the digital video camera 100 may have any configuration as long as the image processing section 160 can perform an operation to be described below.

### 1-3. Operation

Now, an operation of the digital video camera 100 according to the present embodiment will be described. The digital video camera 100 of the present embodiment is capable of changing the frame rate by generating interpolation frame images. Upon receiving a predetermined control command for reproduction, the digital video camera 100 displays an original frame, rather than an interpolation frame, on the display monitor 220.

When the user turns ON the power of the digital video camera 100, the controller 180 supplies power to various sections of the digital video camera 100. The digital video camera 100 has the shooting mode and the playback mode, and can be switched between the shooting mode and the playback mode by a user operation, or the like. After power is supplied, if the digital video camera 100 has been set in the shooting mode, the controller 180 reads out necessary information from the internal memory 230 and initializes the optical system 110, the CMOS image sensor 140, etc., based on the read-out information to set up the camera ready for shooting. Upon completing the setup operation for shooting, the controller 180 controls the CMOS image sensor 140 to capture an image, instructs the recording section 160a of the image processing section 160 so as to convert the image signal, which has been converted by an A/D converter 150 to a digital signal, to a signal that can be displayed as the through image, and performs a control so that the generated through image is displayed on the display monitor 220. By looking at the through image displayed on the display monitor 220, the user can check the angle of view, the object, etc., during the image capturing operation.

The user can depress a movie recording button (a part of the operating member 210) at any point in time to instruct the controller 180 to record a moving picture. Upon receiving an instruction to record a moving picture, the controller 180 processes the image being captured by the CMOS image sensor 140 as a moving picture in a format in conformity with a predetermined standard, and outputs the processed moving picture data to the memory card 200 to record the moving picture data on the memory card 200. On the other hand, the user can depress the movie recording button at any point in time during the movie recording operation to instruct the controller 180 to end the moving picture recording operation.

With the digital video camera 100, it is possible to change the frame rate of the moving picture captured during the movie recording operation. The time when the frame rate is changed may be when a user gives an instruction, when information (e.g., brightness information) obtained from the captured image is changed, or when a predetermined mode (e.g., a low-speed image capturing mode) is selected. Alternatively, the user may program, in advance, a change of the frame rate.

When the frame rate needs to be changed, the image processing section 160 generates an interpolation frame image to be inserted between frame images.

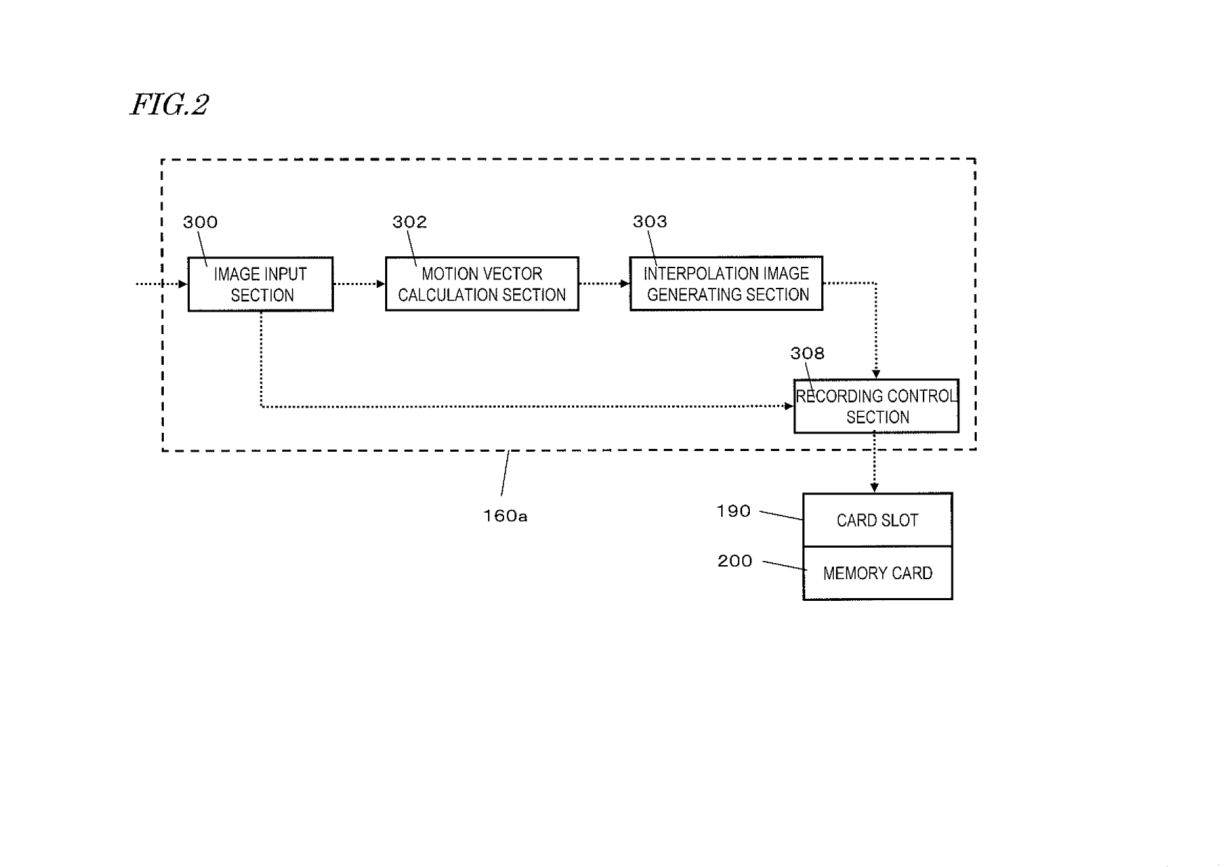

FIG. 2 is a block diagram showing a configuration of the recording section 160a of the image processing section 160. As shown in FIG. 2, the recording section 160a includes the image input section 300, the motion vector calculation section 302 for calculating a motion vector between two consecutive frames, the motion-compensated interpolation image generating section 303 for generating an interpolation frame based on the motion vector, and a recording control section 308.

The image input section 300 receives an image signal that has been generated by the CMOS image sensor 140 and converted by the A/D converter 150 to a digital signal. The image signal is composed of a plurality of frame images, and therefore the frame images are successively received at a predetermined frame rate. The frame images received by the image input section 300 are successively output to the motion vector calculation section 302 and the recording control section 308.

The motion vector calculation section 302 calculates a motion vector from two frame images contiguous in time with each other. Herein, frames contiguous in time with each other refer to two frames that are adjacent to each other along the time axis with no other frames interposed therebetween. The detection of a motion vector is performed by the unit of macroblocks each including 16 pixels×16 pixels, for example. Specifically, between a macroblock in one of the two frames contiguous in time with each other (referred to as the “reference frame”) and another macroblock of 16 pixels×16 pixels that is at the corresponding position in the other frame (referred to as the “search frame”), the brightness value difference between each pair of pixels from these macroblocks whose positions correspond to each other is obtained, and the brightness value differences are summed together to obtain the difference (SAD: Sum of Absolute Difference). The difference is obtained while shifting the macroblock position in the search frame in the horizontal direction and in the vertical direction by one pixel at a time. The difference is calculated at every pixel position across a predetermined search range, i.e., a range spanning a predetermined number of pixels in the horizontal direction and in the vertical direction.

The calculated differences are compared against one another within the search range to determine the macroblock position within the search frame at which the difference takes the minimum. The distance and direction from the center of the macroblock in the reference frame to the center the determined macroblock in the search frame are obtained. Thus, a motion vector is calculated. The motion vector is obtained as described above also for the other macroblocks in the reference frame.

The motion vector calculation section 302 outputs two frames contiguous in time with each other (the reference frame and the search frame), and the motion vector obtained for each macroblock to the motion-compensated interpolation image generating section 303.

The motion-compensated interpolation image generating section 303 shifts the image portion represented by the macroblock in the reference frame to an intermediate position along the motion vector. This process will be hereinafter referred to as motion-compensated interpolation. By performing this process for all the macroblocks in the reference frame, there is generated an interpolation frame image (motion-compensated interpolation frame) to be inserted between two frame images contiguous in time with each other.

The motion-compensated interpolation image generating section 303 outputs the generated interpolation frame image to the recording control section 308. The recording control section 308 successively inserts generated interpolation frame images between corresponding two frame images contiguous in time with each other. Thus, the recording control section 308 outputs a moving picture whose frame rate has been changed.

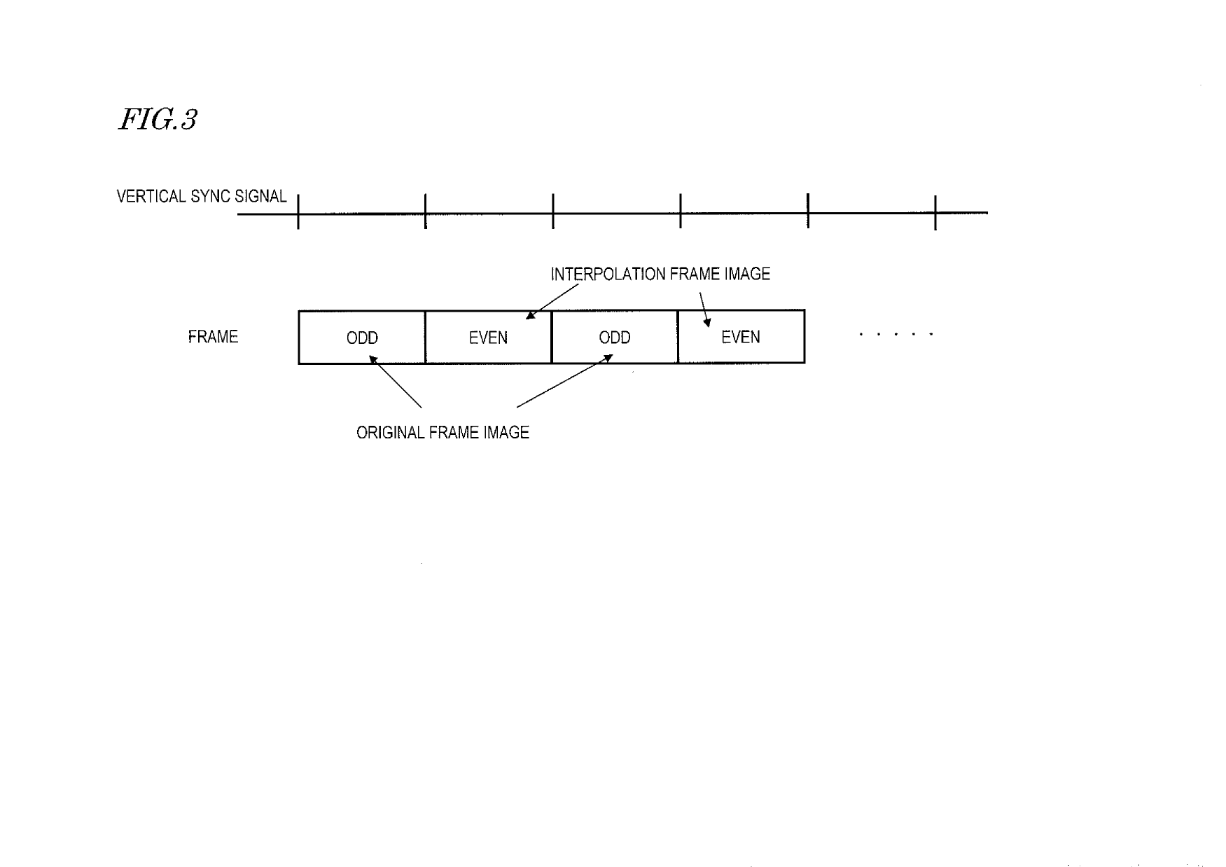

Referring to FIG. 3, how frame images are arranged by the recording control section 308 will be described in detail. FIG. 3 shows the arrangement of frames with respect to the vertical sync signal VD. As shown in FIG. 3, the recording control section 308 defines, in advance, odd-numbered frames and even-numbered frames in accordance with the timing represented by the vertical sync signal received from the controller 180. The recording control section 308 successively arranges original frame images obtained from the image input section 300 in odd-numbered frames, and the motion-compensated interpolation frame images generated by the motion-compensated interpolation image generating section 303 in even-numbered frames. That is, in accordance with the vertical sync signal, original frame images are arranged in odd-numbered frames, and interpolation frame images are inserted in even-numbered frames therebetween. Thus, the recording control section 308 generates data of a series of moving picture frame images including original frame images and interpolation frame images inserted between the original frame images.

The recording control section 308 successively writes and records the data of a series of moving picture frame images on the memory card 200.

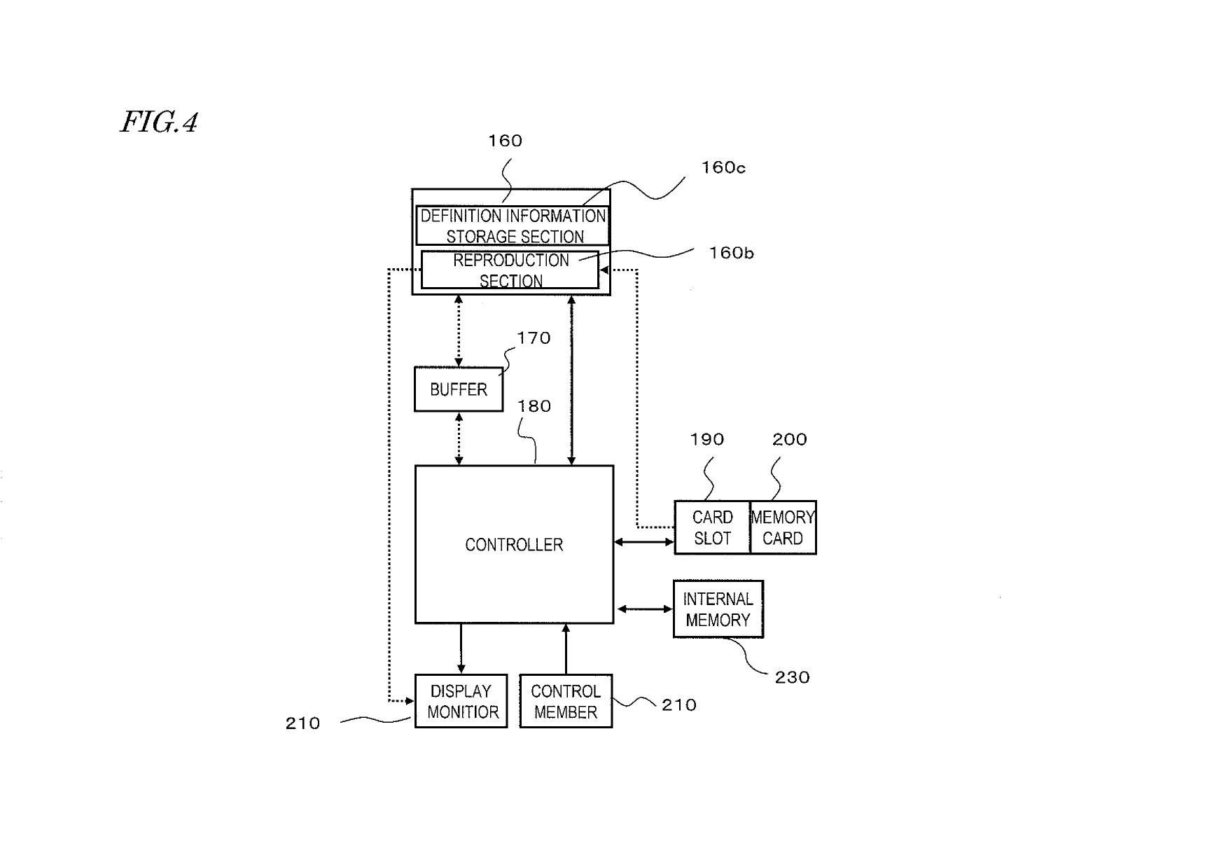

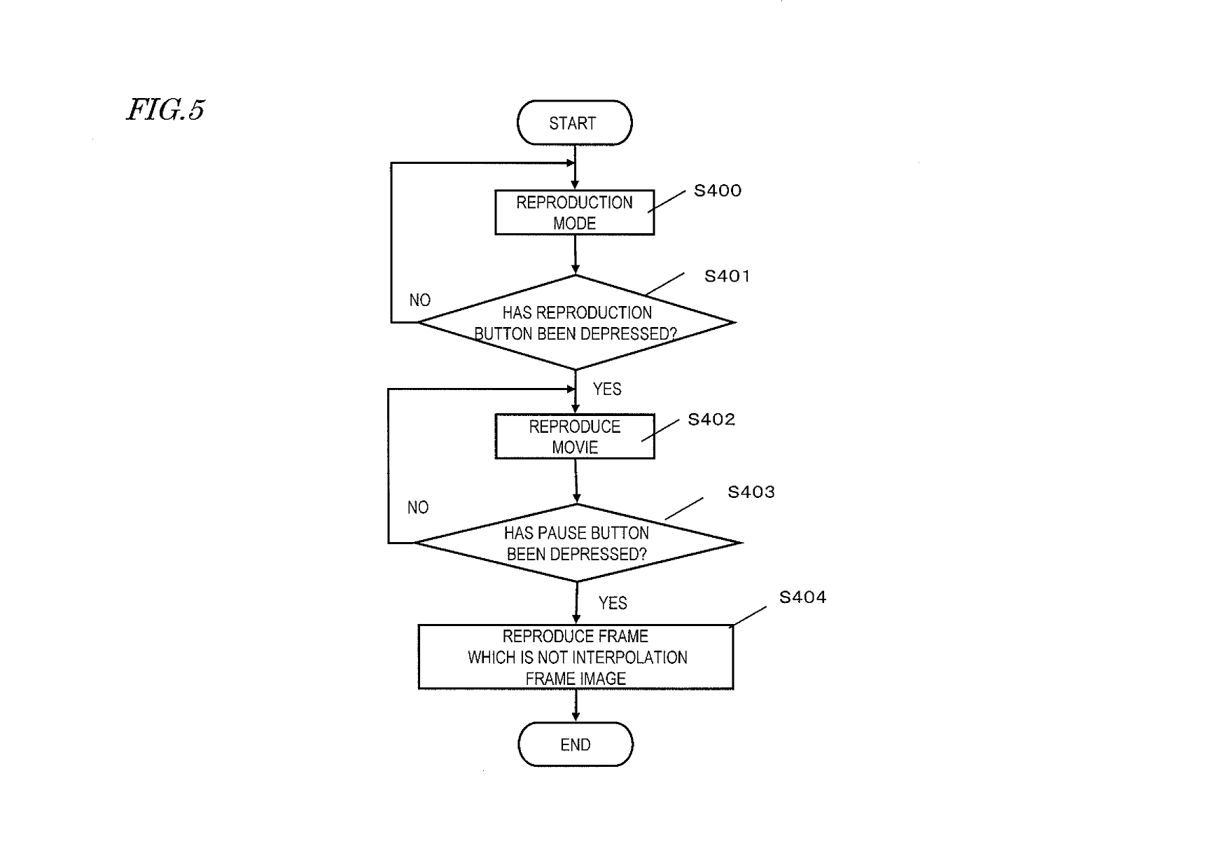

Now, referring to FIGS. 4 and 5, the reproduction operation by the digital video camera 100 according to the present embodiment will be described. FIG. 4 is a block diagram of the reproduction operation by the controller 180 and the reproduction section 160b, and FIG. 5 is a flow chart showing the reproduction operation by the digital video camera 100. As shown in FIG. 4, the image processing section 160 includes the reproduction section 160b for reading out the moving picture data from the memory card 200, and outputting the moving picture data to the display monitor 220. The image processing section 160 may further include a definition information storage section 160c storing information representing the arrangement of original frame images and interpolation frame images.

The user sets the digital video camera 100 in the reproduction mode by operating the shooting mode/reproduction mode switch, which is a part of the operating member 210 (S400).

Upon receiving an instruction from the user, the controller 180 reads out the representative images (thumbnail images) of the image data (including still images and moving pictures) stored in the memory card 200, and displays an array of representative images on the display monitor 220.

Now, consider a case where the user selects a moving picture whose frame rate has been changed, and depresses a reproduction button, which is a part of the operating member 210. In this case, the moving picture data to be reproduced includes images of the original frames, and images of the interpolation frames generated from the original frame images.

The controller 180 monitors whether the reproduction button has been depressed (S401). If the reproduction button has been depressed (Yes in S401), the controller 180 reads out the selected moving picture data from the memory card 200, and controls the reproduction section 160b to perform a predetermined process on the data, which is then output to the display monitor 220. Thus, the video of the moving picture data is displayed on the display monitor 220 (S402).

While the video of the moving picture data is displayed on the display monitor 220, i.e., while the moving picture data is reproduced, the controller 180 monitors whether the user has depressed a pause button, which is a part of the operating member 210 (S403). When receiving a pause instruction as a result of the user depressing the pause button (Yes in S403), the controller 180 controls the reproduction section 160b so as to output one of the original frame images, rather than an interpolation frame image, of the moving picture data being reproduced (S404). The frame definition information of the moving picture data is stored in the definition information storage section 160c of the image processing section 160. The frame definition information is information representing the arrangement of original frame images and interpolation frame images of the moving picture data. In the present embodiment, the original frame images are arranged in odd-numbered frames and the interpolation frame images in even-numbered frames, as described above. The controller 180 controls the reproduction section 160b so as to reproduce a frame image arranged in an odd-numbered frame based on the frame definition information. Specifically, if the reproduction section 160b is outputting data of an original frame image to the display monitor 220 at the point in time when the pause instruction is received, the data of the original frame image is continuously output to the display monitor 220. If data of an interpolation frame image is being output to the display monitor 220 at the point in time when the pause instruction is received, data of an original frame image that is immediately before or after the interpolation frame image is selected and continuously output to the display monitor 220.

If the user depresses the slow reproduction button, instead of the pause button, the reproduction section 160b selectively outputs only the original frame images arranged in odd-numbered frames to the display monitor 220 under the control of the controller 180 based on the stored information on the arrangement of interpolation frames. Thus, the video of only the original frame images is displayed on the display monitor 220.

As described above, when a pause instruction or a slow reproduction instruction is received from the user, the digital video camera 100 selectively displays, on the display monitor, a video of data of the original frame images, rather than interpolation frame images whose image quality is somewhat lower.

### 1-4. Advantageous Effects, Etc.

As described above, according to the present embodiment, the reproduction section 160b is provided for reading out moving picture data from the memory card 200 and outputting the moving picture data to the display monitor 220, and the reproduction section 160b selectively outputs image data of an original frame, of the moving picture data, to the display monitor 220 based on an instruction from the user. Therefore, frame images of a higher image quality than interpolation frame images are presented to the user, and it is possible to give the user a natural video image and natural control feel. During normal reproduction, a video of moving picture data with interpolation frames inserted therein is displayed on the display monitor 220, and it is therefore possible to present to the user a smooth moving picture with interpolation frames inserted therein.

When the user depresses the slow reproduction button, the reproduction section 160b receives a slow reproduction instruction for performing slow reproduction, and selects image data of only original frames from the moving picture data and successively outputs the original frames to the display monitor 220. Thus, it is possible to present to the user a slow reproduction image of a high image quality.

When the user depresses the pause button, the reproduction section 160b receives a pause instruction during reproduction of a moving picture, and continuously outputs image data of one original frame of the moving picture data to the display monitor 220. In this case, image data of an original frame of the moving picture data that is to be reproduced immediately after the pause instruction is received may be continuously output to the display monitor 220, or image data of an original frame of the moving picture data that has been reproduced immediately before the pause instruction is received may be continuously output to the display monitor 220. Then, it is possible to present to the user a still image of a high image quality.

The image processing section 160 may further include the definition information storage section 160c having, stored therein in advance, definition information that defines the arrangement of original frames and interpolation frames of moving picture data. Upon receiving an instruction from the user, the reproduction section 160b may selectively output image data of an original frame from the moving picture data to the display monitor 220 by referencing the definition information.

### 2. Other Embodiments

An embodiment has been described above as an example of the technique disclosed in the present application. However, the technique of this disclosure is not limited thereto, but is also applicable to other embodiments in which changes, replacements, additions, omissions, etc., are made as necessary. Different ones of the elements described in the embodiment above may be combined together to obtain a new embodiment. In view to this, other embodiments are illustrated hereinbelow.

In the present embodiment, the CMOS image sensor 140 is used as an image capturing device, but the image capturing device is not limited thereto. For example, a COD image sensor or an NMOS image sensor may be used as the image capturing device.

The image processing section 160 and the controller 180 may be implemented by a single semiconductor chip, or by separate semiconductor chips.

In the embodiment above, the memory card 200 is used as a medium for recording a moving picture, but the present disclosure is not limited thereto. For example, other recording media such as a hard disk drive (HDD) or an optical disc may be used.

While the embodiment above is directed to operations to be performed when a pause instruction or a slow reproduction instruction is given while reproducing a moving picture on the display monitor 220 of the digital video camera 100, the technique of the present disclosure is not limited thereto. Also when a pause instruction or a slow reproduction instruction is given while reproducing a moving picture stored in the digital video camera 100 on an external display device, to which the digital video camera 100 is connected via a wired connection such as USB cable or a wireless connection such as Wi-Fi, similar advantageous effects can be achieved by performing similar operations based on the information regarding the arrangement of original frame images and interpolation frame images of the moving picture.

The present disclosure is also applicable to cases where the digital video camera 100 is not connected to an external display device. For example, where each file of moving picture data recorded on the memory card 200 is associated with information regarding the arrangement of original frame images and interpolation frame images of the moving picture data, and the moving picture is transferred to a personal computer (PC) or a cloud server, similar advantageous effects can be achieved by performing similar operations to those described in the embodiment above by transferring the moving picture with the arrangement information.

While the embodiment above is directed to operations to be performed when reproduction of a moving picture is paused or the moving picture is reproduced in slow reproduction, the technique of the present disclosure is not limited thereto. The technique of the present disclosure is also applicable to cases where some frames are taken out of a series of frames for purposes other than pause or slow reproduction.

While the recording control section 308 arranges original frame images in odd-numbered frames and interpolation frame images in even-numbered frames in the embodiment above, the present disclosure is not limited thereto. For example, interpolation frame images may be arranged in odd-numbered frames and original frame images in even-numbered frames. In this case, the controller 180 may control the reproduction section 160b so as to reproduce data of a frame image arranged in an even-numbered frame during pause or slow reproduction.

While the embodiment above is directed to a case where video frames are arranged in two sets of frames, i.e., odd-numbered frames and even-numbered frames, the present disclosure is not limited thereto. For example, a video frames may be arranged in a set of four frames, i.e., first frames, second frames, third frames and fourth frames. In such a case, if frame definition information indicating which of the first to fourth frames contains interpolation frames arranged therein is stored in the definition information storage section 160c, it is possible to display an original frame image on the display monitor 220, while avoiding interpolation frame images, during pause or slow reproduction. Where moving picture data is reproduced using such frame definition information, if an interpolation frame image is being output by the reproduction section 160b to the display monitor 220 at the point in time when a pause instruction is received, the controller 180 can control the reproduction section 160b so that the reproduction section 160b reproduces an original frame that is closest in time to the interpolation frame, whether it is before or after the interpolation frame, thereby minimizing the delay from the timing intended by the user.

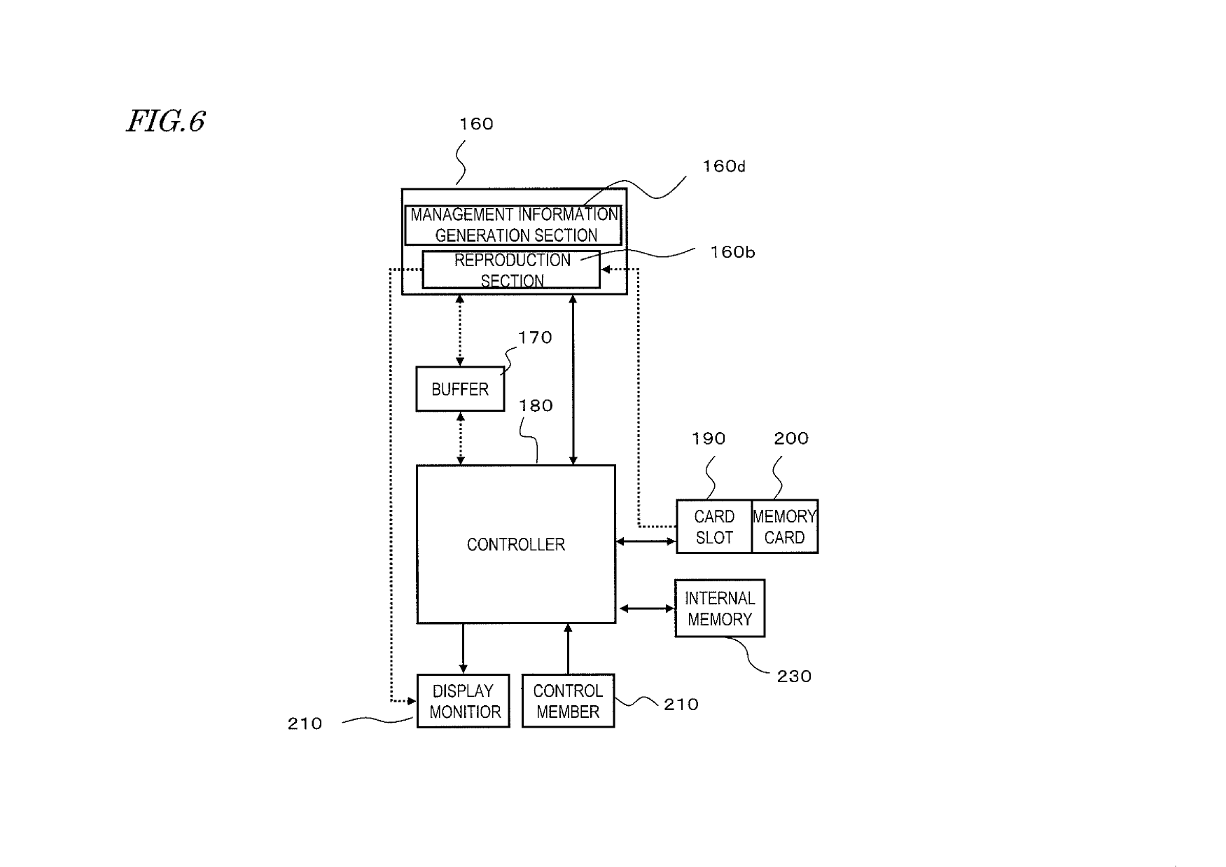

In the embodiment above, frame definition information representing the arrangement of original frame images and interpolation frame images is stored in advance in the definition information storage section 160c. However, the present disclosure is also applicable to cases where the frame definition information is not stored in advance. For example, as shown in FIG. 6, the image processing section 160 may include the reproduction section 160b and a management information generation section 160d. For example, based on an instruction from the controller 180, the management information generation section 160d examines which frame images are arranged at which point in time based on the timing represented by the vertical sync signal in the moving picture data to generate management information used for managing the arrangement, and the management information is stored. In response to an instruction from the controller 180, the reproduction section 160b may determine a frame image to be selected during pause or slow reproduction by using the stored management information, and output the frame image to the display monitor 220. The management information generation section 160d may generate and store the management information when the recording section 160a generates moving picture data, when the moving picture data is stored in the memory card 200, or when the moving picture data is read out from the memory card 200 and output to the display monitor 220 by the reproduction section 160b. This embodiment is suitably applicable to an ordinary frame format including odd-numbered frames and even-numbered frames. Specifically, even with a moving picture of such a frame format that original frame images appear, for example, three times more often than interpolation frame images do, the controller 180 can reliably display an original frame image during pause or slow reproduction by referencing the management information.

In the embodiment above, the definition information storage section 160c and the management information generation section 160d are included in the image processing section 160. However, the definition information storage section 160c and the management information generation section 160d may not be included in the controller 180.

The technique of the present disclosure may be further applicable to software (program) that defines the reproduction operation described above. The operation defined by such a program is as shown in FIG. 5, for example. Such a program may be provided while being stored in a portable storage medium, or may be provided through a telecommunications network. With a processor provided in a computer executing such a program, it is possible to realize the various operations described in the embodiment above.

Embodiments have been described above as an illustration of the technique of the present disclosure. The accompanying drawings and the detailed description are provided for this purpose.

Thus, elements appearing in the accompanying drawings and the detailed description include not only those that are essential to solving the technical problems set forth herein, but also those that are not essential to solving the technical problems but are merely used to illustrate the technique disclosed herein. Therefore, those non-essential elements should not immediately be taken as being essential for the reason that they appear in the accompanying drawings and/or in the detailed description.

The embodiments above are for illustrating the technique disclosed herein, and various changes, replacements, additions, omissions, etc., can be made without departing from the scope defined by the claims and equivalents thereto.

The application of the technique of the present disclosure is not limited to the digital video camera 100. That is, the present disclosure is applicable to image processing apparatuses capable of converting the frame rate, such as digital still cameras, information terminals equipped with cameras, personal computers, and server computers.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2012-002737 filed Jan. 11, 2012, and No. 2013-000802 filed Jan. 8, 2013 the entire contents of which are hereby incorporated by reference.

What is claimed is:

1. A reproduction apparatus for reproducing moving picture data including images of original frames and images of interpolation frames generated from the images of the original frames, the reproduction apparatus comprising:
a reproduction section configured to receive the moving picture data and output the moving picture data to a display section,
wherein the reproduction section selectively outputs image data of an original frame from the moving picture data to the display section based on an instruction from a user.

2. The reproduction apparatus of claim 1, wherein:
the instruction from the user is a slow reproduction instruction for performing slow reproduction; and
when the slow reproduction instruction is received, the reproduction section selects only image data of original frames from the moving picture data and successively outputs the image data of the original frames to the display section.

3. The reproduction apparatus of claim 1, wherein:
the instruction from the user is a pause instruction received while reproducing a moving picture; and
when the pause instruction is received, the reproduction section continuously outputs image data of one of the original frames from the moving picture data to the display section.

4. The reproduction apparatus of claim 1, wherein:
the instruction from the user is a pause instruction received while reproducing a moving picture; and
when the pause instruction is received, the reproduction section continuously outputs, to the display section, image data of an original frame from the moving picture data which was supposed to be reproduced immediately after a point in time when the pause instruction was received.

5. The reproduction apparatus of claim 4, wherein:
the instruction from the user is a pause instruction received while reproducing a moving picture; and
when the pause instruction is received, the reproduction section continuously outputs, to the display section, image data of an original frame from the moving picture data which was reproduced immediately before a point in time when the pause instruction was received.

6. The reproduction apparatus of claim 1, further comprising a definition information storage section which has, stored therein in advance, definition information which defines an arrangement of the original frames and the interpolation frames of the moving picture data,
wherein the reproduction section selectively outputs image data of an original frame from the moving picture data to the display section based on the instruction from the user and the definition information.

7. The reproduction apparatus of claim 1, further comprising a management information generation section for determining, from the moving picture data, management information representing an arrangement of the original frames and the interpolation frames of the moving picture data,
wherein the reproduction section selectively outputs image data of an original frame from the moving picture data to the display section based on the instruction from the user and the management information.

8. An image capturing apparatus comprising:
an image capturing section for generating data of original frame images through an image capturing operation;
a recording section for generating image data of interpolation frames from the original frame images and inserting the image data of the interpolation frames between the original frame images, thereby generating moving picture data; and
a reproduction section for receiving the moving picture data and outputting the moving picture data to a display section,
wherein the reproduction section selectively outputs image data of an original frame from the moving picture data to the display section based on an instruction from a user.

9. A computer program for use with a reproduction apparatus for reproducing moving picture data including images of original frames and images of interpolation frames generated from the images of the original frames, the computer program instructing a computer of a reproduction section for receiving the moving picture data and outputting the moving picture data to a display section to execute the steps of:
receiving the moving picture data and outputting the moving picture data to the display section; and
selectively outputting image data of an original frame from the moving picture data to the display section based on an instruction from a user.
